(19) United States
(12) Patent Application Publication
(10) Pub. No.: US 2023/0410011 A1
(43) Pub. Date: Dec. 21, 2023

(54) Systems, Devices, and/or Methods for Managing Projects

(71) Applicant: Abductive Services LLC, Bryan, TX (US)

(72) Inventor: Chijioke Kingsley Ofoche, Fairburn, GA (US)

(21) Appl. No.: 17/836,951

(22) Filed: Jun. 9, 2022

(51) Int. Cl. G06Q 10/06

(52) U.S. Cl. CPC G06Q 10/0635; G06Q 10/06312

(57) ABSTRACT

Certain exemplary embodiments can provide a method, which comprises, via a set of machine instructions: representing an activity of a project as a node of a graph; representing a relationship of the project as an edge of the graph; utilizing a normal distribution and associated p-values to obtain a first probability of completing the activity in a predetermined time period; and rendering a first user interface that indicates the probability of completing the activity in a predetermined time period.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a side view of an exemplary embodiment of a system 1000;

FIG. 2 is a flowchart of an exemplary embodiment of a method 2000; and

FIG. 3 is a block diagram of an exemplary embodiment of an information device 3000.

### DETAILED DESCRIPTION

Certain exemplary embodiments can provide a method, which comprises, via a set of machine instructions: representing an activity of a project as a node of a graph; representing a relationship of the project as an edge of the graph; utilizing a normal distribution and associated p-values to obtain a first probability of completing the activity in a predetermined time period; and rendering a first user interface that indicates the probability of completing the activity in a predetermined time period.

Current methods adopted by the project scheduling industry utilize a critical path method (“CPM”) and portray project activities as a sequence of time-based bar charts, known as Gantt charts. Such charts can be utilized for closely monitoring and controlling project activities. However, this approach assumes a deterministic one-point estimation of durations and scheduled completion of activities, which often cannot be applied accurately to certain real-life projects.

Another approach was developed by the U.S. Navy in around 1958 named, Program Evaluation and Review Technique (“PERT”), which employs a probabilistic three-point estimate to ascertain the levels of schedule and cost variability in a project. While PERT has benefits for estimating an amount of uncertainty in attaining specified project deadlines and budgets, PERT has been utilized in early planning and pre-execution phases of projects and has challenges concerning continuous updates once the project has begun.

Certain exemplary embodiments utilize PERT techniques in day-to-day monitoring and control of projects. Certain exemplary embodiments provide various codes and queries that have been constructed for extracting useful information about the project status and likelihood of meeting schedule and/or cost goals. Certain exemplary embodiments comprise machine instructions that are executed on a Neo4j (Neo4j is a registered trademark of Neo Technology of San Mateo CA) graph database management system and can be run on local computers, distributed networks, and/or on cloud-based servers. Certain exemplary embodiments utilize a normal distribution (also called the z-distribution) and associated p-values for obtaining probabilities of achieving test results (i.e., completing projects and/or activities before a given time and within a specified budget). The normal distribution (z-distribution), p-values, and queries for deriving case relevant probabilities have been implemented in machine instructions, based on logic, path and pattern matching queries written in the Cypher Query Language. In certain exemplary embodiments, a PERT methodology can be used (as well several variants such as a modified PERT and/or triangular distribution, etc.), in conjunction with CPM. Certain exemplary embodiments utilize path finding and shortest path algorithms (such as Dijkstra's shortest path algorithms, A* algorithm, k-shortest paths, single source shortest path, all-pairs shortest path) to determine critical and near-critical paths with activity/task durations being mapped to path weights and relationships applied to the graph directions.

Certain exemplary embodiments provide a methodology for quickly assessing the levels of uncertainty contained in a schedule by representing activities as nodes (or vertices) and relationships as edges. Relationships between predecessors and successors are utilized in this application, including: Finish-to-Start, Start-to-Start, Finish-to-Finish, and Start-to-Finish. Certain exemplary embodiments provide a methodology based on logic, path and pattern matching queries written in the Cypher Query Language. Lags and leads are also utilized in exemplary machine instructions. Certain exemplary embodiments utilize queries written in the Cypher Query Language for performing Forward and Backward passes on project schedules, thus the Early Start, Early Finish, Late Start, Late Finish, Free Float, and/or Total Float (or Slack) are determined. Certain exemplary embodiments compute and keep track of a project's critical path at every point in time, levels of risk and probabilities of achieving various milestones and budget targets, resource allocation and distribution, and a joint or combined schedule and cost risk at any desired confidence level. Certain exemplary embodiments provide a novel implementation of the standard normal distribution (z-distribution) and its p-values, which are utilized to quantify the schedule and/or cost uncertainties and confidence levels. Risks can then be integrated to evaluate and ascertain the pre- and post-risk mitigation outcomes.

Certain exemplary embodiments are constructed for evaluating schedule health based on industry best practices and standards, such as the U.S. Defense Contract Management Agency (DCMA) 14-point assessment and customized quality checks. A track of the schedule and cost performance can be maintained by applying Earned Value Management techniques, and S-curves, which have all been implemented in machine instructions based on logic and pattern matching. Plots and charts can be plotted to aid the visualization of activities and resources and the uncertainty levels across the project path. Certain exemplary embodiments can be utilized as a standalone tool or in combination with other machine instructions.

Certain exemplary embodiments are constructed for performing machine learning and graphing algorithms such as Betweenness Centrality on weighted paths to be applied in novel ways to project schedules to provide business intelligence and rank the most critical activities. Due to rich interactivity of a schedule portrayed as a system of nodes and edges, what-If scenario analysis can be performed swiftly, to gauge, experiment, and optimize approaches out of a myriad of alternatives based on logic, path and pattern matching queries written in the Cypher Query Language.

Certain exemplary embodiments provide a method that comprises simplifying an understanding of project scheduling and factors that drive project planning. Certain exemplary embodiments utilize visual techniques to enhance applications of providing foundations of project scheduling. By use of unconventional methods, complicated pathways are rendered easy to grasp with the aid of network analysis to represent activities as nodes and their relationships as edges. Critical path(s) and an evolvement of such are easily detected. Potential risks to successful schedule actualization can be quantified, eliminated, and/or managed. Unlike certain exemplary deployed Critical Path Method (CPM) processes that utilize a deterministic approach, certain exemplary embodiments employ a novel implementation of a PERT process for a probabilistic assessment and scheduling of projects. Interactive nodes in a network can be used to highlight and control activities, resources, cost, and risks. Forward and backwards passes can be automated, and the underlying structures of huge, complicated schedules can be captured and visualized by use of Neo4j graphical machine instructions. Algorithms for computations and queries of schedules based on the network properties have been developed. Never before applied graph network and machine learning concepts are combined and channeled towards project scheduling (such as, betweenness centrality, graph traversals, pattern matching, distance and path algorithms, closeness, node importance, historical graph evolution tracking, and link prediction) to uncover hidden patterns and derive deeper understanding of trends than can be achieved by use of certain other methods. Certain exemplary embodiments ties key principles together to introduce a powerful and novel tool to meet modern scheduling challenges and equip an entire planning team with a methodology that changes the paradigm in future project control and management.

Certain exemplary embodiments provide interactive graph networks for visualizing and representing project activities as nodes; algorithms for computations and queries of the schedule based on the network properties, machine learning for project scheduling, automated back and forward passes, probabilistic PERT analysis, plus CPM, schedule risk, and cost risk analyses.

Certain exemplary embodiments provide for visualization of activities as interactive nodes and their paths as edges, algorithms for computations and queries of the schedule based on the network properties, automated forward and backwards passes help pave the way for assessing the schedule health and interactivity of critical activities in a schedule; machine learning to allow machine learning from patterns in project schedules.

Certain exemplary embodiments provide enriched visualization and interactivity of project activities, which are represented as nodes in a graph network. This enables for the application of PERT analysis concepts to analyze project scheduling and incorporate risk forecasting. Machine learning techniques are applied on the graph to enable the computer to learn from the structure of the schedule. Advanced queries and algorithms for computations on the schedule based on the network properties have been developed.

Certain exemplary embodiments comprise of codes and algorithms which have been developed with the goal of simplifying the application of network analysis to project scheduling. Any project schedule can be easily represented as a graph network to deduce rich insights. Certain exemplary embodiments provide written codes and queries to automatically solve the common business questions, as well as portray project activities as nodes for enhanced visualization and profound interactivity. The visualization capabilities brought about by the depiction of the project schedule as a system of interactive nodes carries with it an enormous level of information that surpasses the conventional Gantt charts used in certain processes. Certain exemplary embodiments provide information directly from queries written to automate and filter out specific details about project activities. Certain exemplary embodiments can be utilized as a standalone tool or in conjunction with additional machine instructions constructed for analyzing various aspects of the project schedule.

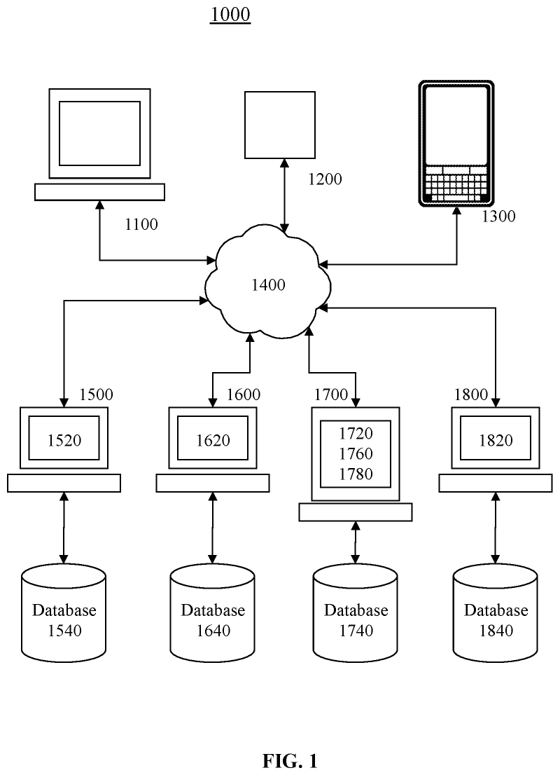

FIG. 1 is a block diagram of an exemplary embodiment of a system 1000, which can comprise a smartphone 1300, an information device 1100, tablet 1200, a network 1400, a first server 1500, a second server 1600, a third server 1700, and a fourth server 1800. First server 1500 can comprise a first user interface 1520 and can be coupled to a first database 1540. Second server 1600 can comprise a second user interface 1620 and can be coupled to a second database 1640. Third server 1700 can comprise a third user interface 1720, a processor 1760, machine instructions 1780, and can be coupled to a third database 1740. Fourth server 1800 can comprise a fourth user interface 1820 and can be coupled to a fourth database 1840. Any of the methods and/or steps thereof can be carried out in whole or in part by tablet 1200, smartphone 1300, information device 1100 and/or first server 1500. Second server 1600, third server 1700, and/or fourth server 1800 can each be associated with implementation of a system via which projects are planned and/or managed. In certain exemplary embodiments, system 1000 can be used to implement one or more methods disclosed herein.

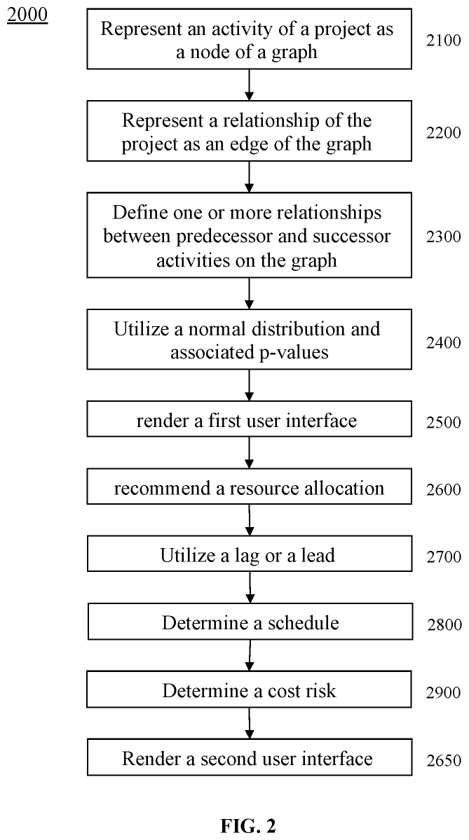

FIG. 2 is a flowchart of an exemplary embodiment of a method 2000. At activity 2100, via a set of machine instructions, an activity of a project is represented as a node of a graph. In certain exemplary embodiments, the node of the graph is an interactive node via which the activity of the project is controlled.

At activity 2200, via a set of machine instructions, a relationship of the project is represented as an edge of the graph.

At activity 2300, via a set of machine instructions, one or more relationships between predecessor and successor activities on the graph is defined. The relationships can comprise at least one of:

Finish-to-Start;

Start-to-Start;

Finish-to-Finish; and/or

Start-to-Finish.

At activity 2400, a normal distribution and associated p-values can be utilized to:
obtain a first probability of completing the activity in a predetermined time period; and/or
obtain a second probability of completing the activity within a specified budget.

At activity 2500, a first user interface is rendered. The first user interface can indicate a first probability of completing the activity in a predetermined time period.

In certain exemplary embodiments, the first user interface is rendered responsive to at least one of:
betweenness centrality;
graph traversals;
pattern matching;
distance and path algorithms;
closeness;
node importance; and/or
historical graph evolution tracking; and prediction.

At activity 2600, a resource allocation is recommended for the project.

At activity 2700, at least one of a lag and a lead is utilized by the machine instructions.

At activity 2800, a schedule is automatically determined at a predetermined confidence level.

At activity 2900, a cost risk is automatically determined at a predetermined confidence level.

At activity 2950, a second user interface is rendered. The second user interface can:
show a critical path for the project;
show a level of risk for the project.
show a probability of achieving a milestone for the project;
show a probability of achieving budget target for the project;
plot a chart indicative of uncertainty levels along a path of the project;
show an automatically determined a joint schedule risk and a cost risk at a predetermined joint confidence level;
showing a changed or defined a relationship type to adjust a schedule of the project;
show an updated schedule of the project over time;
render an indicator of project performance via Earned Value Management based on computations derived from a PERT methodology;
show resources represented as nodes to allow renderings and analysis both labor and non-labor resource allocation;
render a schedule of the project, the schedule based upon forward and backward passes between graph nodes to determine an: Early Start, Early Finish, Late Start, Late Finish, Total Float (Slack), and/or Free Float; and
show a “health” of a schedule of the project by quality checks conducted or evaluated based on user-defined criteria.

In certain exemplary embodiments, the set of machine instructions is executed on a Neo4j graph database management system.

In certain exemplary embodiments, the probability of completing the activity of the project in a predetermined time period is determined responsive to machine learning.

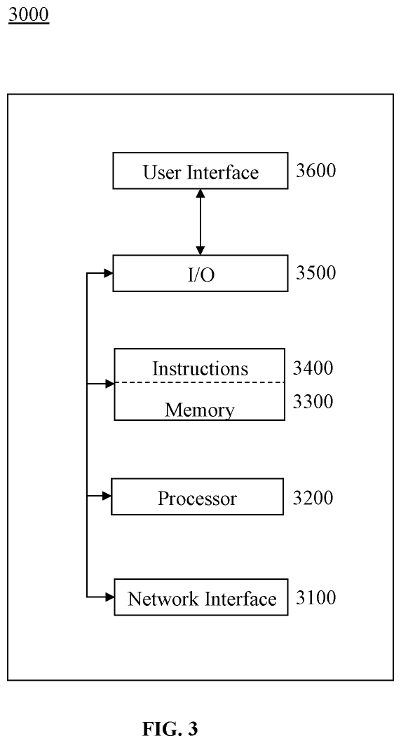

FIG. 3 is a block diagram of an exemplary embodiment of an information device 3000, which in certain operative embodiments can comprise, for example, information device 1100, tablet 1200, smartphone 1300, and/or first server 1500 of FIG. 1. Information device 3000 can comprise any of numerous circuits and/or components, such as for example, one or more network interfaces 3100, one or more processors 3200, one or more memories 3300 containing instructions 3400, one or more input/output devices 3500, and/or one or more user interfaces 3600 coupled to one or more input/output devices 3500, etc.

In certain exemplary embodiments, via one or more user interfaces 3600, such as a graphical user interface, a user can view a rendering of information related to researching, designing, modeling, creating, developing, building, manufacturing, operating, maintaining, storing, marketing, selling, delivering, selecting, specifying, requesting, ordering, receiving, returning, rating, and/or recommending any of the products, services, methods, and/or information described herein.

Certain exemplary embodiments can utilize any of a variety of graph databases and/or libraries such as, Neo4j, InfiniteGraph (InfiniteGraph is a registered trademark of Objectivity, Inc. of San Jose CA), igraph (igraph is open source software), NetworkX (NetworkX is a Python library and free software for studying graphs and networks), TIBCO Graph Database (TIBCO is a registered trademark of TIBCO Software Inc. of Palo Alto CA), Dgraph Labs (Dgraph is a registered trademark of Dgraph Labs, Inc. of Houston TX), Amazon Neptune (Amazon Neptune is a registered trademark of Amazon Technologies, Inc. of Seattle WA), OrientDB (OrientDB is open source software), TigerGraph (TigerGraph is a registered trademark of TigerGraph, Inc. of Redwood City, CA), etc.

Certain exemplary embodiments can utilize any of a variety of query languages such as Cypher Query Language (which is an open source language utilized with Neo4j), but could be applicable to other languages such as Apache TinkerPop Gremlin (Apache TinkerPop Gremlin is open source software), SPARQL (SPARQL is open source software), Graph Query Language (“GQL”, which is open source software), and codes written in other computing languages such as Python (Python is open source software), R (R is open source software), etc.

Certain exemplary embodiments can utilize alternative graph models, e.g., Labeled-Property Graph models, and/or Resource Description Framework (“RDF”) models, etc.

A labeled-property graph model is represented by a set of nodes, relationships, properties, and labels. Both nodes of data and associated relationships are named and can store properties represented as key-value pairs. Nodes can be labeled and/or grouped. Edges representing the relationships can have two qualities: they can have a start node and an end node, and are directed, making the graph a directed graph. Relationships can also have properties. Direct storage of relationships allows a substantially constant-time traversal.

RDF models are directed graphs comprising triple statements. An RDF graph statement is represented by: 1) a node for a subject, 2) an arc that goes from a subject to an object for a predicate and 3) a node for the object. Each of the three parts of the statement can be identified by a Uniform Resource Identifier. An object can also be a literal value.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
achieve—to carry out successfully.
ACID—an acronym of the words atomicity, consistency, isolation, durability, which defines a set of properties of database transactions intended to guarantee data validity despite errors, power failures, and other mishaps.
activity—an action, act, step, and/or process or portion thereof
adapted to—made suitable or fit for a specific use or situation.
adjust—to change to a sought state.
allocation—a process of distributing something.
allow—to position so as to facilitate an action.
analysis—an evaluation.
and/or—either in conjunction with or in alternative to.
apparatus—an appliance or device for a particular purpose.
associate—to join, connect together, and/or relate.
automatically—acting or operating in a manner essentially independent of external influence or control. For example, an automatic light switch can turn on upon “seeing” a person in its view, without the person manually operating the light switch.
backward pass—a method used to move through a project network diagram in reverse order; a backward pass identifies late start and late finish values, so that a project's duration and/or critical path can be estimated.
betweenness centrality—a measure of centrality in a graph based on shortest paths.
budget—a financial plan for a defined time period.
can—is capable of, in at least some embodiments.
cause—to produce an effect.
change—to make different.
closeness—an average length of a shortest path between a node and all other nodes in a graph.
complete—substantially whole or entire.
comprising—including but not limited to.
confidence level—a probability that something will occur.
configure—to make suitable or fit for a specific use or situation.
constructed to—made to and/or designed to.
control—to direct one or more activities.
convert—to transform, adapt, and/or change.
cost risk—a risk that a project will spend more money than was originally estimated and/or budgeted.
CPM—an acronym for critical path method, which is an algorithm utilized for scheduling a set of project activities.
create—to bring into being.
critical path—one or more activities that define a longest stretch for competition where, when more than one activity is present in the critical path, one or more later activities must occur after one or more prior activities.
Cypher Query Language—a declarative graph query language that allows for expressive and efficient data querying in a property graph.
define—to establish the outline, form, or structure of
determine—to obtain, calculate, decide, deduce, and/or ascertain.
device—a machine, manufacture, and/or collection thereof.
distance and path algorithms—a method that analyzes a graph for predicted time intervals in one or more predetermined sequences of activities.
Earned Value Management—a method that measures an amount of work actually performed on a project and forecasts the project's total cost and date of completion, based on trend analysis.

Oftentimes the term “earned value” is defined as the “budgeted cost of worked performed” or BCWP. This budgeted cost of work performed measure enables the project manager to compute performance indices or burn rates for cost and schedule performance,
Early Finish—an earliest possible point in time on which uncompleted portions of an activity (or the project) can finish, based on the network logic and any schedule constraints utilizing a critical path method.
edge—an model of a relationship between a first activity and a second activity.
estimate—to calculate and/or determine approximately and/or tentatively.
evaluate—to calculate or estimate.
Finish-to-Finish—a dependency in which a first activity must be completed before a second activity can be completed.
Finish-to-Start—a dependency in which a first activity must be completed before a second activity can begin.
forward pass—a method used to move forward through a project network diagram; a backward pass determines a project's duration and/or critical path.
Free Float—an amount of time that a task can be delayed without impacting a subsequent task.
generate—to create, produce, give rise to, and/or bring into existence.
graph—a mathematical structure used to model pairwise relations between activities.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
historical graph evolution tracking—a record of how potential project activity organization changes over time.
importance—a measure of significance of an activity in a project.
indicate—to signify.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of utilizing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
initialize—to prepare something for use and/or some future event.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
Integrated Cost and Schedule Risk Analysis—a method that utilizes project cost information and provides both: (1) more accurate cost estimates than if the schedule risk were ignored or incorporated only partially, and (2) illustrates the importance of schedule risk to cost risk when the durations of activities using labor-type (time-dependent) resources are risky.
interactive—related to an action that occurs between users and information devices via user interfaces.
hard logic—planning rules specifying tasks that must be completed before a successor task can start.
health—an evaluation of a project schedule that determines whether (1) any tasks are missing predecessors or successors; (2) there are any hard constraints; (3) there are any out of sequence activities; and/or (4) whether there are any issues with relationship types in the project schedule.
Joint Confidence Interval—a process in an integrated cost and schedule risk analysis that estimates a chance that both cost and schedule meet a certain confidence level; the process combines a project's cost, schedule, and risk into a complete picture.
joint confidence level—a confidence level that reflects both cost and schedule risks in a project.
joint schedule risk—a likelihood of failing to meet schedule plans and the effect of that failure.
labor—work performed by a human.
lag—to occur later in time.
Late Finish—a latest time an activity can finish, without delaying a finish time of a project.
Late Start—a latest time an activity can start without affecting a planned project finish date.
lead—to occur before in time.
level of risk—an probability that a desired process might not be completed.
logic—a
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine learning—algorithms information devices use in order to perform a specific task effectively without using explicit instructions, relying on patterns and inference instead. It is seen as a form of artificial intelligence
machine readable medium—a physical structure from which a machine can obtain data and/or information. Examples include a memory, punch cards, etc.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
milestone—a significant point of progress in a process.
Neo4j graph database management system—an ACID-compliant transactional database with native graph storage and processing of Neo4j, Inc. of San Mateo, CA.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, Ethernet card, cable modem, digital subscriber line interface, bridge, hub, router, or other similar device.
node—a point on a graph indicative of an activity of a project.
non-labor—work performed in some manner that does not utilize a human.
normal distribution—a type of continuous probability distribution for a real-valued random variable; the probability density function is:

$$f ( x ) = \frac{1}{σ \sqrt{2 π}} {e}^{- \frac{1}{2} {( \frac{x - μ}{σ} )}^{2}}$$

where μ is the mean of the distribution and a is the square root of the standard deviation of the distribution.
obtain—to receive or determine.
p-value—a probability of obtaining test results at least as extreme as a result actually observed, under an assumption that a null hypothesis is correct.
pattern matching—comparing a given sequence of activities for a known or predicted ordering of activities.
perform—to accomplish something.
performance—activity. Performance can be measured by a characteristic indicative of an activity.
PERT—an acronym for “program evaluation and review technique”, which is a statistical tool used in project management that was designed to analyze and represent the tasks involved in completing a given project.
plurality—the state of being plural and/or more than one.
predetermined—established in advance.
predict—to foretell on the basis of observation, experience, and/or scientific reason.
probability—a quantitative representation of a likelihood of an occurrence.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, California. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
project—a planned undertaking that comprises a plurality of activities.
provide—to furnish, supply, give, and/or make available.
quality checks—tests that determine whether a project schedule is correct.
query—a precise request for information retrieval from a project management database.
receive—to get as a signal, take, acquire, and/or obtain.
recommend—to suggest, praise, commend, and/or endorse.
relate—to connect to and/or associate with.
relationship—a connection and/or association between a first activity and a second activity.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
repeatedly—again and again; repetitively.
represent—to specify in a particular model embodied within a specific set of machine instructions.
request—to express a desire for and/or ask for.
resource—an asset utilized during a project.
resource allocation—an assignment of assets to a task.
schedule—a procedural plan that indicates a time when one or more services will be provided.
select—to make a choice or selection from alternatives.
set—a related plurality.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
slack—a time interval that a task in a project network can be delayed without delaying subsequent tasks or an overall project.
soft logic—planning rules specifying tasks that can be worked in any order, but must be related to another task.
specify—to include in a description of work to be done.
Start-to-Finish—a dependency in which a first activity must begin before a second activity is completed.
Start-to-Start—a dependency in which a first activity must begin before a second activity can begin.
store—to place, hold, and/or retain data, typically in a memory.
substantially—to a great extent or degree.
system—a collection of mechanisms, devices, machines, articles of manufacture, processes, data, and/or instructions, the collection designed to perform one or more specific functions.
target—an objective.
time—when something occurs.
time period—a time interval.
Total Float—an amount of time that a task can be delayed without impacting an overall project completion time.
transmit—to send as a signal, provide, furnish, and/or supply.
traversal—related to modeling motion along a path in a graph.
type—a number of things having in common traits or characteristics that distinguish them as a group or class.
uncertainty level—a probability that something might not occur.
update—to change.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
via—by way of and/or utilizing.
weight—a value indicative of importance.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A method comprising:
via a set of machine instructions:
representing an activity of a project as a node of a graph;
representing a relationship of the project as an edge of the graph;
utilizing a normal distribution and associated p-values to obtain a first probability of completing the activity in a first predetermined time period; and
rendering a first user interface that indicates the first probability of completing the activity in the first predetermined time period.

2. The method of claim 1, further comprising:
utilizing the normal distribution and associated p-values to obtain a second probability of completing the activity within a specified budget.

3. The method of claim 1, further comprising:
defining one or more relationships between predecessor and successor activities on the graph comprising at least one of:
Finish-to-Start;
Start-to-Start;
Finish-to-Finish; and
Start-to-Finish.

4. The method of claim 1, further comprising:
utilizing at least one of a lag and a lead via the machine instructions.

5. The method of claim 1, further comprising:
rendering a second user interface showing a critical path for the project.

6. The method of claim 1, further comprising:
rendering a second user interface showing a level of risk for the project.

7. The method of claim 1, further comprising:
rendering a second user interface showing a probability of achieving a milestone for the project.

8. The method of claim 1, further comprising:
rendering a second user interface showing a probability of achieving budget target for the project.

9. The method of claim 1, further comprising:
recommending a resource allocation for the project.

10. The method of claim 1, further comprising:
automatically determining a schedule risk at a predetermined confidence level.

11. The method of claim 1, further comprising:
automatically determining a cost risk at a predetermined confidence level.

12. The method of claim 1, further comprising:
plotting a chart indicative of uncertainty levels along a path of the project.

13. The method of claim 1, wherein:
the set of machine instructions is executed on a Neo4j graph database management system.

14. The method of claim 1, wherein:
a second probability of completing the activity of the project in a second predetermined time period is determined responsive to machine learning.

15. The method of claim 1, wherein:
the node of the graph is an interactive node via which the activity of the project is controlled.

16. The method of claim 1, wherein:
the first user interface is rendered responsive to at least one of:
betweenness centrality;
graph traversals;
pattern matching;
distance and path algorithms;
closeness;
node importance; and
historical graph evolution tracking; and prediction.

17. The method of claim 1, further comprising:
automatically determining a joint schedule risk and a cost risk at a predetermined joint confidence level.

18. The method of claim 1, further comprising:
changing or defining a relationship type to adjust a schedule of the project.

19. The method of claim 1, further comprising:
updating a schedule of the project over time.

20. The method of claim 1, further comprising:
rendering an indicator of project performance via Earned Value Management based on computations derived from a PERT methodology.

21. The method of claim 1, further comprising:
representing resources as nodes to allow renderings and analysis both labor and non-labor resource allocation.

22. The method of claim 1, further comprising:
rendering a schedule of the project, the schedule based upon forward and backward passes between graph nodes to determine an: Early Start, Early Finish, Late Start, Late Finish, Total Float (Slack), and Free Float.

23. The method of claim 1, further comprising:
conducting quality checks or evaluating a “health” of a schedule of the project based on user-defined criteria.
